(19) United States
(12) Patent Application Publication
(10) Pub. No.: US 2016/0349915 A1
(43) Pub. Date: Dec. 1, 2016

(54) Specified Position Detection Device

(71) Applicant: NEWCOM TECHNO INC., Saitama-shi, Saitama (JP)

(72) Inventors: Yasushi SEKIZAWA, Saitama (JP); Kenji TAHARA, Kuki-shi, Saitama (JP)

(21) Appl. No.: 14/432,718

(22) PCT Filed: Feb. 18, 2014
(86) PCT No.: PCT/JP2014/000817

§ 371 Date: Mar. 31, 2015

(51) Int. Cl. G06F 3/041; G06F 3/0488; G06F 3/046

(52) U.S. Cl. CPC G06F 3/0418; G06F 3/046; G06F 3/04886

(57) ABSTRACT

To improve accuracy of coordinate specified results.

In a coordinate position specifying surface 3 that has an edge region surrounding an inner region, based on detection outputs V4 and V3 of an edge-region first loop coil J4 and adjacent inner-region second loop coil J3, and a coil pitch K02 between the first and second loop coils J4 and J3, a coordinate deviation from the first loop coil J4 to a peak coordinate value p of a specified coordinate detection output W0 is detected. Therefore, it is possible to realize a specified position detection device that can expand, with high accuracy, position coordinates specified by a position specifying tool 5 in such a way as to cover the edge region.

### TECHNICAL FIELD

The present invention relates to a specified position detection device, and is suitably applied to an information processing device having a tablet display surface, for example.

### BACKGROUND ART

An information processing device having a tablet display surface is frequently used as a means to enable a user to specify a specific display position on the tablet display surface and easily carry out processing of information corresponding to the specified display position.

As for this kind of information processing device, as detection means for detecting a position specified by a user on the tablet display surface that is formed by an XY coordinate system, what is proposed is an electromagnetic coupling system that is so configured as to detect, when a position specifying tool containing a parallel resonance circuit, a magnetic substance, and the like is brought closer to a coordinate position on the display surface with a large number of loop coils provided in the display surface, the coordinate position as a position specified by the user (See Patent Documents 1 and 2).

### PRIOR ART DOCUMENTS

### Patent Documents

[Patent Document 1] Japanese Patent Application Laid-open Publication No. 7-44304
[Patent Document 2] Japanese Patent Application Laid-open Publication No. 2010-85378

### SUMMARY OF THE INVENTION

### Problems to be Solved by the Invention

For the information processing device having the tablet display surface, using as simple a configuration as possible to detect a user's specified position on the display surface in such a way as to maintain as high a degree of detection accuracy as possible is effective as a means to increase the utility of the information processing device.

In particular, in an electromagnetic coupling-type position specified detection device, a large number of loop coils are disposed on the display surface, and a position specified signal is obtained from the loop coils with the help of electromagnetic coupling between the loop coils and the position specifying tool. Therefore, the position detection signal obtained from a loop coil located at an edge of the tablet display surface tends to be unstable. Accordingly, the signal needs to be captured as a valid position detection signal through interpolation calculation.

The present invention has been made in view of the above points, and is to provide a specified position detection device that carries out an interpolation calculation process to a detection signal obtained particularly from a loop coil disposed in an edge region, among loop coils for detecting of position, to obtain a highly accurate position detection signal.

### Means for Solving the Problems

To solve the above problems, according to the present invention, a specified position detection device 4 that obtains, when a position is specified by an electromagnetic coupling-type position specifying tool 5 on a coordinate position specifying surface 3 on which a plurality of loop coils X1 to XN, Y1 to YM making up an XY coordinate system are disposed, a specified coordinate detection output from a loop coil X1 to XN, Y1 to YM electromagnetically coupled with the position specifying tool 5 among the loop coils X1 to XN, Y1 to YM located at the specified position, characterized in that: based on a first position detection output value V4, which is obtained from a first loop coil J4 located in an edge region surrounding an inner region, a second position detection output value V3, which is obtained from second loop coils J3 located in the inner region that are adjacent to an inner side of the first loop coil J4, and a first coil pitch K02 between the first and second loop coils, an interpolation operation is performed of a coordinate deviation value from the first loop coil J3 to a peak coordinate value p of the specified coordinate detection output W0 in order to detect coordinates of the position specified by the position specifying tool 5.

### Advantages of the Invention

According to the present invention, in a coordinate position specifying surface that has an edge region surrounding an inner region, based on detection outputs of the edge-region first loop coil and the adjacent inner-region second loop coil, and the coil pitch between the first and second loop coils, a coordinate deviation from the first loop coil to a peak coordinate value of a specified coordinate detection output is detected. Therefore, it is possible to realize a specified position detection device that can expand, with high accuracy, position coordinates specified by a position specifying tool in such a way as to cover the edge region.

### BRIEF DESCRIPTION OF THE DRAWINGS

FIG. 1 is a schematic diagram showing an information processing device that includes a specified position detection device according to the present invention.

FIG. 2 is a schematic connection diagram showing details of a specified position detection unit of FIG. 1.

FIG. 3 is a signal waveform diagram showing a specified position detection operation.

FIGS. 4(A) and 4(B) are schematic diagrams showing the arrangement configuration of three or two loop coils.

FIGS. 5(A) and 5(3) are signal waveform diagrams showing expected waveform of detection outputs obtained from an inner region and an edge region.

FIG. 6 is a schematic diagram used for explanation of inner-region interpolation calculation.

FIG. 7 is a signal waveform diagram used for explanation of parallel translation of a quadratic function.

FIG. 8 is a schematic diagram used for explanation of edge-region interpolation calculation.

FIG. 9 is a signal waveform diagram showing the waveform of a measured signal used for edge-region interpolation calculation.

FIG. 10 is a graph used for explanation of effects of large and small coil pitches.

FIGS. 11(A) and 11(3) are signal waveform diagrams used for explanation of effects of corrections made to coil pitches when K11 is large and when K11 is small.

FIG. 12 is a schematic diagram used for explanation of a valid region expanded to cover an edge region.

FIG. 13 is a schematic diagram used for explanation of loop coils dedicated to touch buttons.

FIG. 14 is a schematic diagram used for explanation of a frame of a tablet display plate unit.

### EMBODIMENTS FOR CARRYING OUT THE INVENTION

With reference to the accompanying drawings, an embodiment of the present invention will be described in detail.

### (1) Overall Configuration of Information Processing Device

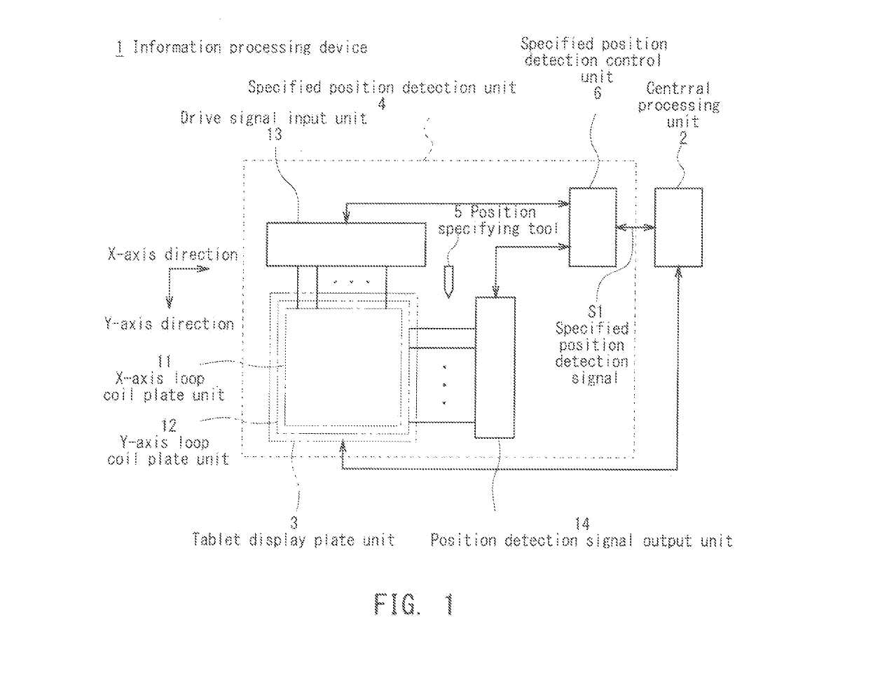

In FIG. 1, reference numeral 1 represents an information processing device as a whole. A central processing unit 2 exchanges information with a tablet display plate unit 3. Therefore, in a specified position detection unit 4 that contains the tablet display plate unit 3, when a user specifies a specific position on an XY display surface of the tablet display plate unit 3 by using a position specifying tool 5, a specified position detection signal S1, which indicates the specified position, is output from a specified position detection control unit 6 to the central processing unit 2. The central processing unit 2 then carries out processing of corresponding information.

The tablet display plate unit 3 includes an X-axis loop coil plate unit 11 and a Y-axis loop coil plate unit 12; the X-axis loop coil plate unit 11 and the Y-axis loop coil plate unit 12 are disposed in such a way that their entire display surfaces overlap with each other. The Y-axis loop coil plate unit 12 is controlled by a drive signal input unit 13, which is controlled by the specified position detection control unit 6, to control inputting of signals in a Y-axis direction on the tablet display plate unit 3.

Moreover, the X-axis loop coil plate unit 11 is controlled by a detection signal output unit 14, which is controlled by the specified position detection control unit 6, to control detecting of position in an X-axis direction.

### (2) Specified Position Detection Unit

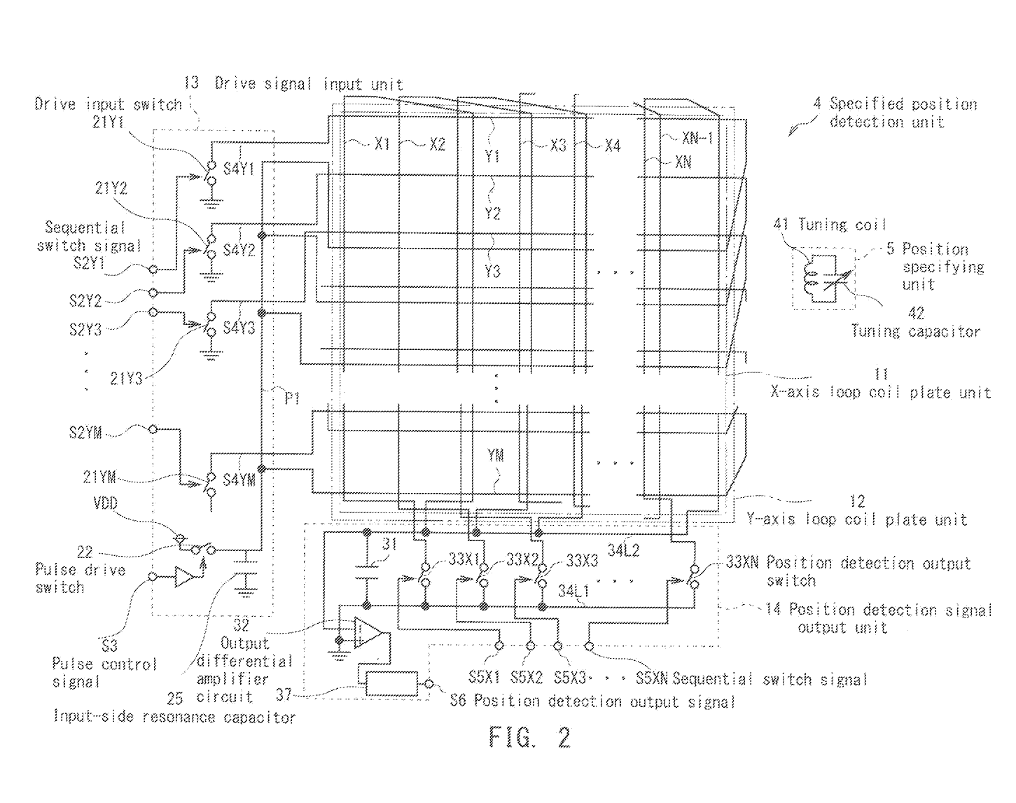

In the X-axis loop coil plate unit 11, as shown in FIG. 2, a plurality of, or N (e.g. 32), X-axis loop coils X1, X2, . . . , XN are sequentially disposed in an X-axis direction (or horizontal direction in FIG. 2) in such a way as to be longitudinally long and extend in a longitudinal direction as well as to be parallel to each other.

The X-axis loop coils X1, X2, . . . , XN each are a straight conductive wire that is wound once in such a way as to have a longitudinally long rectangular shape in the longitudinal direction. Therefore, at X-axis-direction center positions of the X-axis loop coils X1, X2, . . . , XN, N coordinate positions that are located at regular intervals in the X-axis direction on the XY display surface can be identified.

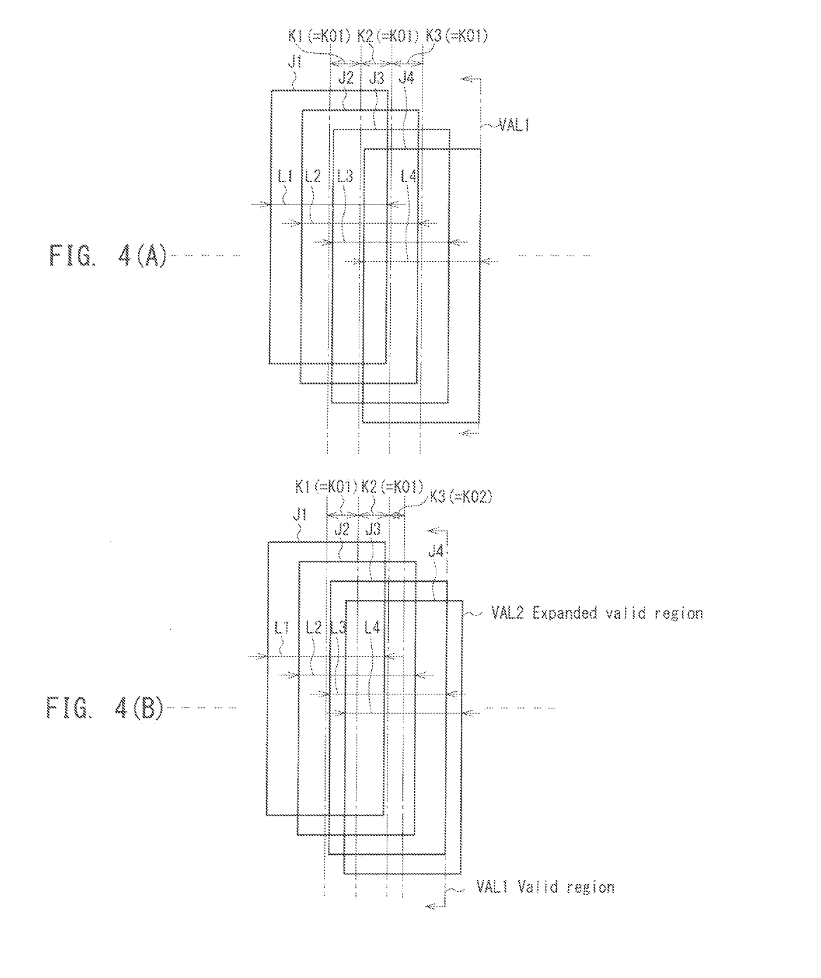

According to this embodiment, the positions of the X-axis loop coils X1, X2, . . . , XN are so determined that, in the X-axis direction, the adjacent X-axis loop coils partially overlap with one another in such a way as to spread in a width direction (e.g. four loop coils J1 o J4 that overlap as shown in FIG. 4). To a position detection signal obtained from each of the overlapping loop coils, X-axis-direction interpolation calculation is carried out, thereby improving the accuracy of detecting a specified position.

In the Y-axis loop coil plate unit 12, in FIG. 2, a plurality of, or M (e.g. 20), Y-axis loop coils Y1, Y2, . . . , YM are sequentially disposed in the longitudinal direction in such a way as to be horizontally long and extend in a horizontal direction as well as to be parallel to each other.

The Y-axis loop coils Y1, Y2, . . . , YM each are a straight conductive wire that is wound once in such a way as to have a longitudinally long rectangular shape in the horizontal direction. Therefore, at Y-axis-direction center positions of the Y-axis loop coils Y1, Y2, . . . , YM, M coordinate positions that are located at regular intervals in the Y-axis direction on the XY display surface can be identified.

According to this embodiment, the positions of the Y-axis loop coils Y1, Y2, . . . , YM are so determined that, in the Y-axis direction, the adjacent Y-axis loop coils partially overlap with one another in such a way as to spread in a width direction (e.g. four loop coils J1 o J4 that overlap as described above with reference to FIG. 4). To a position detection signal obtained from the overlapping loop coils, Y-axis-direction interpolation calculation is carried out, thereby improving the accuracy of detecting a specified position.

Actually, the X-axis loop coil plate unit 11 and the Y-axis loop coil plate unit 12 are stacked in such a way that an insulating material layer is sandwiched therebetween. In this manner, the X-axis loop coils X1, X2, . . . , XN and the Y-axis loop coils Y1, Y2, . . . , YM are positioned in such a way as to be perpendicular to each other and in a grid pattern.

As a result, when a user specifies any XY coordinate position on the tablet display plate unit 3 using the position specifying tool 5, the coordinates of the specified position can be determined based on the positions where the X-loop coils X1, X2, . . . , XN are disposed in the X-axis direction and on the positions where the Y-axis loop coils Y1, Y2, . . . , YM are disposed in the Y-axis direction.

One ends of the Y-axis loop coils Y1, Y2, . . . , YM of the Y-axis loop coil plate unit 12 are connected to the ground via drive input switches 21Y1, 21Y2, . . . , 21YM, which are provided in the drive signal input unit 13.

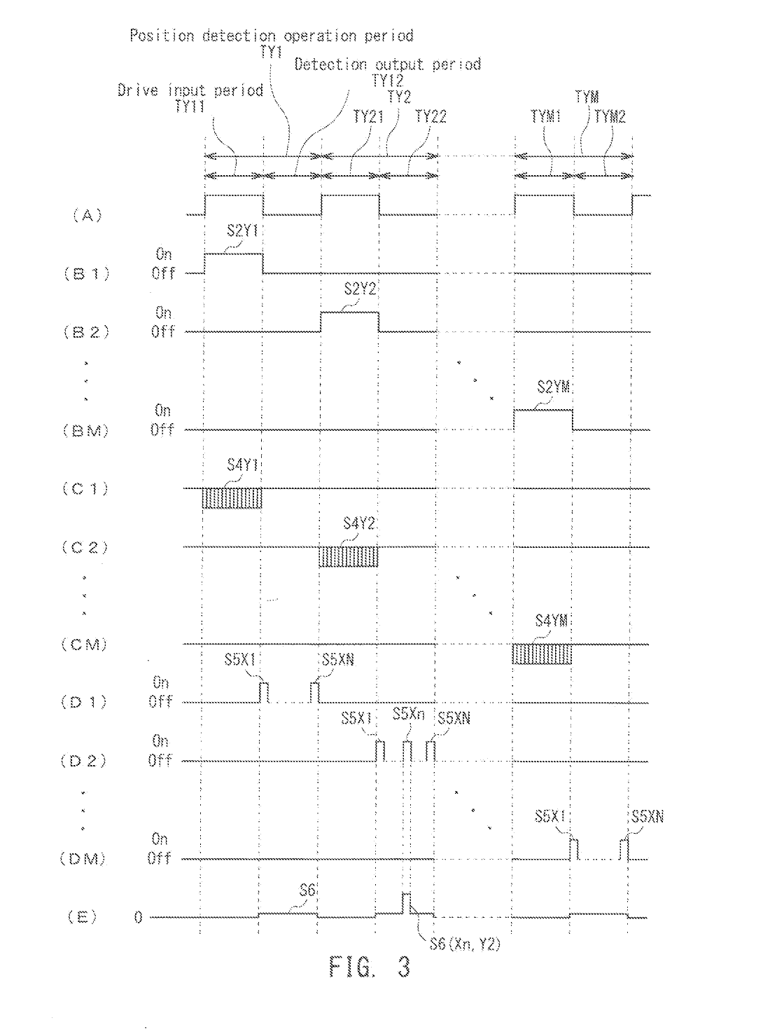

The drive input switches 21Y1, 21Y2, . . . , 21YM are controlled in such a way as to be turned ON or OFF at the timing shown in FIG. 3 (B1), (B2), . . . , (BM) in response to sequential switch signals S2Y1, S2Y2, . . . , S2YM given from the specified position detection control unit 6.

In the case of this embodiment, to the Y-axis loop coils Y1, Y2, . . . , YM, as shown in FIG. 3(A), position detection operation periods TY1, TY2, . . . , YM of a predetermined duration are sequentially assigned. The first half of those periods are used as drive input periods TY11, TY21, . . . , TYM1, in which the sequential switch signals S2Y1, S2Y2, . . . , S2YM are activated to an ON-control level (FIG. 3 (B1), (B2), . . . , (BM)). Therefore, during the first-half periods, to the Y-axis loop coils Y1, Y2, . . . , YM, drive pulse signals S4Y1, S4Y2, . . . , S4YM are supplied (FIG. 3 (C1), (C2), . . . , (CM)).

One ends of the Y-axis loop coils Y1, Y2, . . . , YM are connected to a power supply terminal to receive power VDD from the specified position detection control unit 6 via a pulse drive switch 22, which is provided in the drive signal input unit 13.

The pulse drive switch 22 is controlled in such a way as to be turned ON or OFF at predetermined pulse intervals in response to a pulse control signal S3 supplied from the specified position detection control unit 6. Therefore, as shown in FIG. 3 (B1), (B2), . . . , (BM), as the drive input switches 21Y1, 21Y2, . . . , 21YM are controlled by the drive input signals S2Y1, S2Y2, . . . , S2YM in such a way as to be turned ON, the drive pulse signals S4Y1, S4Y2, . . . , S4YM are sequentially supplied to the Y-axis loop coils Y1, Y2, . . . , YM via a common connection line P1 at the timing shown in FIG. 3 (C1), (C2), . . . , (CM).

The common connection line P1 for the pulse drive switch 22 and the Y-axis loop coils Y1, Y2, . . . , YM are grounded via a input-side resonance capacitor 25. Therefore, when the drive pulse signals S4Y1, S4Y2, . . . , S4YM are supplied to the Y-axis loop coils Y1, Y2, . . . , YM, the Y-axis loop coils Y1, Y2, . . . , YM each form a parallel resonance circuit along with the input-side resonance capacitor 25.

The resonance frequency of the parallel resonance circuits, which are formed by the Y-axis loop coils Y1, Y2, . . . , YM and the input-side resonance capacitor 25, is set to an ON/OFF frequency of the power VDD that is supplied via the pulse drive switch 22. Therefore, when each of the Y-axis loop coils Y1, Y2, . . . , YM forms each parallel resonance circuit, a large current can flow therethrough. As a result, during the drive input periods TY11, TY12, . . . , TYM2, or first-half portions of the position detection operation periods TY1, TY2, . . . , TYM, the Y-axis loop coils Y1, Y2, . . . , YM can generate strong drive magnetic fields.

One ends of the X-axis loop coils X1, X2, . . . , XN of the X-axis loop coil plate unit 11 are connected to a non-inverting input terminal of an output differential amplifier circuit 32 through position detection output switches 33X1, 33X2, . . . , 33XN, which are provided in the position detection signal output unit 14 in such a way as to correspond to the X-axis loop coils X1, X2, . . . , XN, and then through a common connection line 34L1. The other ends of the X-axis loop coils X1, X2, . . . , XN are connected in common to each other, and are connected to an inverting input terminal of the output differential amplifier circuit 32 via a common connection line 34L2.

To the position detection output switches 33X1, 33X2, . . . , 33XN, sequential switch signals S5X1, S5X2, . . . , S5XN are supplied from the specified position detection control unit 6. As shown in FIG. 3 (D1), (D2), . . . , (DM), during the detection output periods TY12, TY22, . . . , TYM2, or the last-half portions of the position detection operation periods TY1, TY2, . . . , TYM, as ON-operations are sequentially carried out, induced voltages generated at the X-axis loop coils X1, X2, . . . , XN are input between the non-inverting input terminal and inverting input terminal of the output differential amplifier circuit 32 via the position detection output switches 33X1, 33X2, . . . , 33XN.

In the case of the present embodiment, between the common connection lines 34L1 and 34L2 of the one and other ends of the X-axis loop coils X1, X2, . . . , XN, an output-side resonance capacitor 31 is connected. Therefore, as the X-axis loop coils X1, X2, . . . , XN are sequentially ON-operated, parallel resonance circuits are sequentially formed by the X-axis loop coils X1, X2, . . . , XN and the output-side resonance capacitor 31. At this time, an induced resonance voltage generated at both ends of the output-side resonance capacitor 31 is given to the non-inverting input terminal and inverting input terminal of the output differential amplifier circuit 32 as a position detection output.

The position specifying tool 5 includes a resonance loop, which has a tuning coil 41 and a tuning capacitor 42. As described above with reference to FIG. 3, during the position detection operation periods TY1, TY2, . . . , TYM, provided for the Y-axis loop coils Y1, Y2, . . . , YM, as the drive inputs S2Y1, S2Y2, . . . , S2YM are supplied during the drive input periods TY11, TY21, . . . , TYM1, and as a resonance current flows through the Y-axis loop coils Y1, Y2, . . . , YM, magnetic fields are generated. At this time, a tuned resonance current that is tuned to the magnetic fields flows through the tuning coil 41 and the tuning capacitor 42, leading to accumulation of a tuned resonance energy.

In the case of the present embodiment, a tuning frequency of the tuning coil 41 and the tuning capacitor 42 is set to a value that matches a resonance frequency of a resonance current of the Y-axis loop coils Y1, Y2, . . . , YM, enabling efficient accumulation of the resonance energy of the resonance current of the Y-axis loop coils Y1, Y2, . . . , YM in the tuning resonance loop.

Therefore, through the tuning coil 41 and the tuning capacitor 42, a tuned resonance current of a resonance frequency that is determined by the tuning coil 41 and the tuning capacitor 42 continues flowing during the detection output periods TY12, TY22, . . . , TYM2, which follow the drive input periods TY11, TY21, . . . , TYM1, thereby inducing an induced electromotive force on the X-axis loop coils X1, X2, . . . , XN based on the tuned resonance current.

As for the induced current that is induced on the X-axis loop coils X1, X2, . . . , XN, as described above in FIG. 3 (D1), (D2), . . . , (DM), during each of the detection output periods TY12, TY22, . . . , TYM2, when the position detection output switches 33X1, 33X2, . . . , 33XN are ON-operated, the induced current carries out a resonance operation together with the output-side resonance capacitor 31. As a result, a resonance voltage that is obtained at both ends of the output-side resonance capacitor 31 is sequentially transmitted as a position detection output signal S6 via the output differential amplifier circuit 32 and then via a synchronous detection circuit 37.

### (3) Specified Position Detection Operation

In the above configuration, when a user specifies a position by moving the position specifying tool 5 toward, for example, coordinate position (Xn, Y2) among XY coordinates on the X-axis loop coil plate unit 11 and Y-axis loop coil plate unit 12 of the tablet display plate unit 3, for the Y-axis loop coil plate unit 12, the specified position detection control unit 6 performs an ON-operation of the drive input switch 21Y2 using a sequential switch signal S2Y2 of the drive signal input unit 13, and also performs a pulse output drive operation of the pulse drive switch 22. As a result, during the drive input period TY21, or a first-half portion of the position detection operation period TY2 of FIG. 3, a resonance input current flows through the Y-axis loop coil Y2 because of the Y-axis loop coil Y2 and the input-side resonance capacitor 25.

At this time, the position specifying tool 5 is located at a position close to the Y-axis loop coil Y2. As a result, the tuning coil 41 is electromagnetically coupled with magnetic fields generated by a drive resonance current that flows through the Y-axis loop coil Y2, thereby providing drive-input energy to the position specifying tool 5.

In this state, as shown in FIG. 3 (D2), during the detection output period TY22 of the position detection operation period TY2 of the Y-axis loop coil Y2, the position detection signal output unit 14 sequentially starts ON-operations of the position detection output switches 33X1, 33X2, . . . , 33Xn, . . . , 33XN using the sequential switch signals S5X1, S5X2, . . . , S5Xn, . . . , S5XN.

At this time, the tuning coil 41 of the position specifying tool 5 works to generate a tuned resonance current on the X-axis loop coil Xn, which is specified by the user. However, since the other X-axis loop coils X1, X2, . . . , Xn−1, Xn+1, . . . , XN are not located adjacent to the position specifying tool 5, a tuned resonance current is unlikely to be generated at the X-axis loop coils other than X-axis loop coil Xn.

When the position detection output switch 33XN of the position detection signal output unit 14 is turned ON, a induced current that is induced on the X-axis loop coil Xn helps to keep the situation where an induced resonance current flows due to the output-side resonance capacitor 31.

At both ends of the output-side resonance capacitor 31 of the position detection signal output unit 14, a large induced resonance voltage is formed due to the resonance operation. The voltage is transmitted as a position detection output signal S6 via the output differential amplifier circuit 32 and the synchronous detection circuit 37.

When the other position detection output switches 33X1, 33X3, . . . , 33XN except the position detection output switch 33XN are ON-operated, induced resonance voltages are generated on corresponding X-axis loop coils X1, X3, . . . , XN based on resonance currents of the tuning coil 41 and tuning capacitor 42 of the position specifying tool 5; the values of the induced resonance voltages are not greater than the voltage of the inverting input terminal. Therefore, a voltage level of the output terminal of the output differential amplifier circuit 32 becomes smaller.

Moreover, even if a resonance current from the input-side resonance capacitor 25 flows through the Y-axis loop coils Y1, Y3, . . . , YM except the one at coordinates (Xn, Y2) specified by the position specifying tool 5 as the drive input switches 21Y1, 21Y2, . . . , 21YM are ON-operated, the position specifying tool 5 is not located adjacent to the Y-axis loop coils Y1, Y3, . . . , YM, and therefore the tuning coil 41 of the position specifying tool 5 cannot carry out a tuning operation, thereby not leading to the situation where a sufficient value of tuned resonance current flows through the tuning coil 41 and the tuning capacitor 42.

In that manner, even if the Y-axis loop coils Y1, Y3, . . . , YM form the resonance circuits with the output-side resonance capacitor 31 as the position detection output switches 33X1, 33X3, . . . , 33XN are ON-operated, a sufficiently large induced resonance current does not flow from the tuning coil 41 and tuning capacitor 42 of the position specifying tool 5 into the parallel resonance circuits that are formed between the X-axis loop coils X1, X3, . . . , XN and the output-side resonance capacitor 31. Therefore, in effect, from the output differential amplifier circuit 32, a detection output cannot be obtained.

As a result, from the position detection signal output unit 14, as shown in FIG. 3(E), as for the X-axis loop coil Xn that is interlinked with the Y-axis loop coil Y2 in such a way as to correspond to the coordinates (Xn, Y2) specified by the position specifying tool 5, during the detection output period TY22, position detection output signal S6 (Xn, Y2) is output at the timing when the X-axis loop coil Xn is ON-operated.

As for the detection outputs that are obtained from the X-axis loop coils X1, X2, . . . , XN and obtained in the output differential amplifier circuit 32, a plurality of detection outputs are obtained from a plurality of X-axis loop coils near a specified position depending on the deviation of the X-axis loop coils X1, X2, . . . , XN and Y-axis loop coils Y1, Y2, . . . , YM from a central position of the specified position within the width. Accordingly, a coordinate position interpolation means provided in the central processing unit 2 carries out an interpolation operation from the detection outputs to calculate a specified position detection signal corresponding to the specified position.

According to the above configuration, when a user specifies a coordinate position on the tablet display plate unit 3 using the position specifying tool 5, tuning energy is supplied from the drive signal input unit 13 to the tuning coil 41 and tuning capacitor 42 of the position specifying tool 5 located at the specified position, thereby inducing an tuned resonance current on the X-axis loop coil Xn connected to the position detection signal output unit 14 from the position specifying tool 5. As a result, a detection output that indicates the coordinate position (Xn, Y2) specified by the position specifying tool 5 can be obtained.

In that manner, as the resonance current flows from the input-side resonance capacitor 25 of the input-side Y-axis loop coils Y1, Y2, . . . , Yn, . . . , YM, large energy can be given to the position specifying tool 5 with simple configuration. As a result, a tuning resonance operation can be performed. Moreover, due to the tuning resonance operation of the position specifying tool 5, the output X-axis loop coils X1, X2, . . . , XN carry out an induced resonance operation together with the output-side resonance capacitor 31, thereby making sure to obtain a large value of the detection output corresponding to the coordinate position (Xn, Y2) where the tool is positioned.

In that manner, the configuration is relatively simple as a whole, and this configuration makes it possible to obtain the position detection output signal S6 indicating the coordinate position (Xn, Y2), which is specified by the position specifying tool 5, with high accuracy.

### (4) Detection Output Signals of Loop Coils

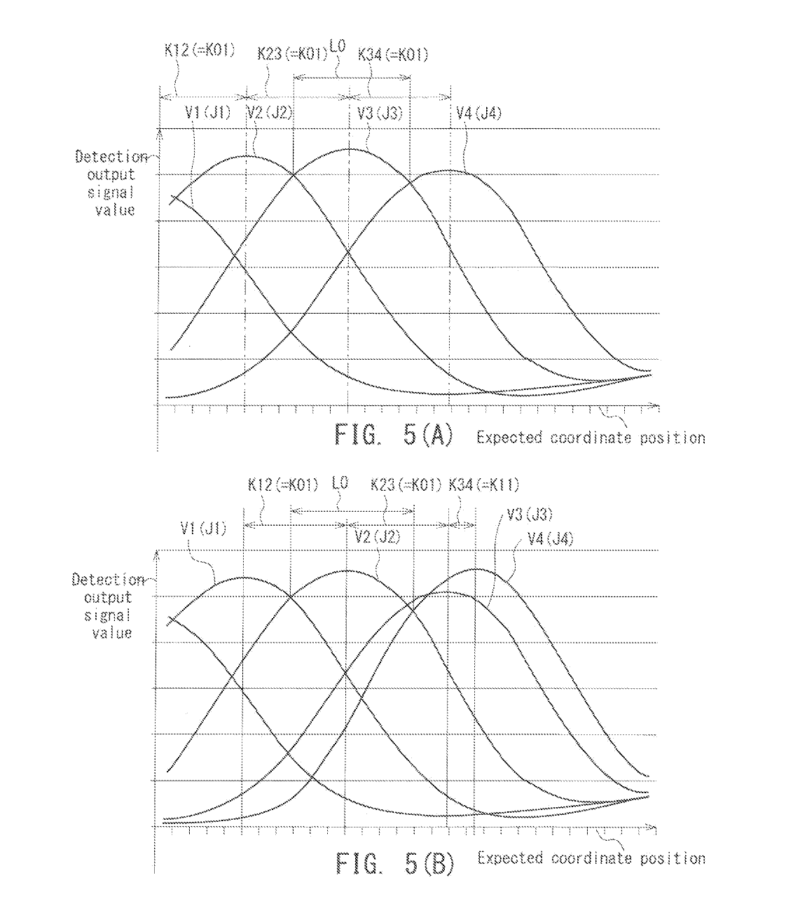

The X-axis loop coils X1, X2, . . . , XN and Y-axis loop coils Y1, Y2, . . . , YM of the specified position detection unit 4 are arranged in such a way that the adjacent loop coils overlap with each other in the X- and Y-directions as shown in FIG. 4 (which is called overlap). From each loop coil, as shown in FIG. 5, the detection output signals are obtained.

FIG. 4(A) focuses on four X-axis loop coils J1, J2, J3, and J4, which are located in an inner region of the X-axis loop coil plate unit 11, showing the state where an interpolation operation is carried out based on the detection output signals of three loop coils J2, J3, and J4. FIG. 4(B) focuses on the four loop coils J1 to J4, with respect to the inner region of the X-axis loop coil plate unit 11 and an edge region that surrounds the inner region, showing the state where an interpolation operation is carried out based on two outer-side loop coils J3 and J4.

The loop coils J1 to J4 have coil widths L1 to L4, respectively. Coil pitches K1, K2, and K3 are formed to indicate the distance between the center positions of the loop coils J1 and J2, the distance between the center positions of the loop coils J2 and J3, and the distance between the center positions of the loop coils J3 and J4, respectively.

Suppose that, against the loop coils J1, J2, J3, and J4 that are arranged as described above, the position specifying tool 5 is operated in such a way as to specify a position in the X-axis direction. As shown in FIGS. 5(A) and 5(B), as the expected coordinate position on a horizontal axis is moved, detection output signals V1, V2, V3, and V4 are obtained from the loop coils J1, J2, J3, and J4.

The output levels of the detection output signals V1, V2, V3, and V4 are changed in such a way as to show a mountain-shaped waveform, which is approximate to a quadratic function equation, with peaks located at the expected coordinate positions of the central positions of coil widths L1, L2, L3, and L4.

The loop coil that is in a coordinate range L0 in which the highest output level is observed among the adjacent waveforms (e.g. the loop coil J3 in FIG. 5) is a loop coil whose position is specified by the position specifying tool 5. The coordinate range L0 contains the position that is actually specified by the position specifying tool 5.

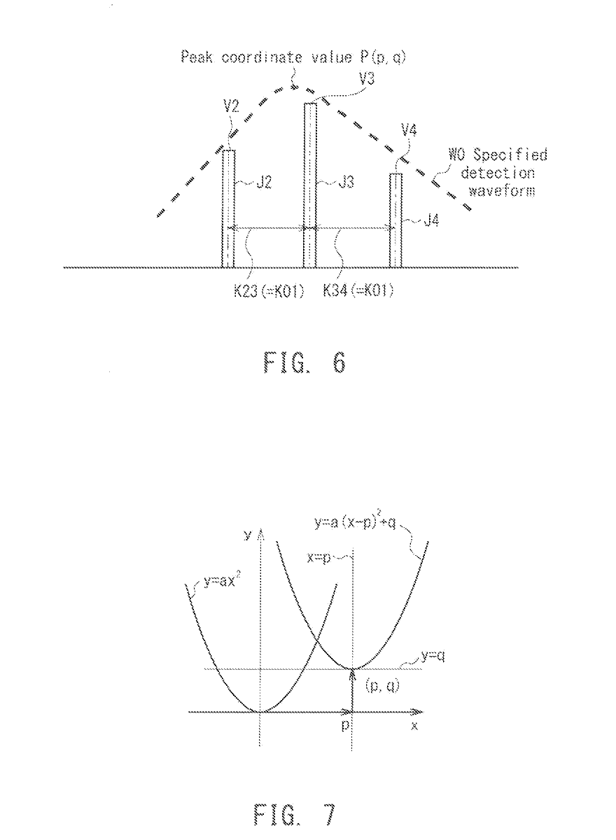

In fact, as shown in FIG. 6, if the specified position detection unit 4 predicts a specified position detection waveform W0 in a coordinate range where the output level of the detection output signal V3 of the center loop coil J3 is larger than those of the detection output signals V2 and V4 of the adjoining loop coils J2 and J4, it was found through experiments that a coordinate position of peak coordinate point P that is actually detected in the coordinate range is deviated from the central coordinate position of the loop coil J3 or a coordinate position thereof.

In the present embodiment, an interpolation operation equation that can identify the amount of deviation of the coordinates is acquired from the relationship between one loop coil J3 and the adjacent two loop coils J2 and J4 (FIGS. 4(A) and 5(A)), which are on both sides thereof, for inner-region interpolation operation; or the interpolation operation equation is acquired from the relationship between the adjoining two loop coils J3 and J4 (FIGS. 4(B) and 5(B)) for edge-region interpolation operation.

### (5) Inner-Region Interpolation Operation

In the case of FIGS. 4(A) and 5(A), in addition to the loop coils J1 to J4 of the X-axis loop coil plate unit 11, the values of coil pitches K12, K23, and K34 are equal to each other and set to value K01. Therefore, the central processing unit 2 uses the following formula.

$$\begin{matrix} [ Formula 1 ] & \\ X = \frac{( V 2 - V 4 ) \times \{ ( Coil Pitch K 01 \div 2 ) \}}{2 \times V 3 - V 2 - V 4} + ( Coil Number of J 3 ) \times ( Coil Pitch K 01 ) & ( 1 )\end{matrix}$$

In that manner, the central processing unit 2 calculates specified position coordinates X that are specified by the position specifying tool 5, based on the three loop coils J3 and J2 and J4.

In the formula (1), V3 represents a detection output value of the center loop coil J3, among the three loop coils J2 to 34; V2 is a detection output value of the loop coil J2, which is located on an inner side of the center loop coil J3 and adjacent to the center loop coil J3; V4 is a detection output value of the loop coil J4, which is located on an outer side of the center loop coil J3 and adjacent to the center loop coil J3; and K01 is a coil pitch from the center loop coil J3 to the loop coils J2 and J4.

The first term of the formula (1) represents the amount of coordinate deviation from the center coordinates of the center loop coil J3 to the coordinates of the position specified by the position specifying tool 5.

The second term of the formula (1) represents the coordinates of the center loop coil J3 on the X-axis loop coil plate unit 11.

### (5-1) Method of Deriving a Specified Position Coordinate Operation Expression for Inner Region

In the coordinate calculation with the formula (1), as a specified position detection waveform W0 shown in FIG. 6, when the central processing unit 2 calculates coordinates (p, q) of the peak P based on the detection outputs V3 and V2 and V4 obtained from the three loop coils J3 and J2 and J4, the coordinate p of the peak P of the specified position detection waveform W0 is judged with the use of a quadratic function formula as an approximate conversion function, because the changes in the detection outputs V3 and V2 and V4 (FIG. 5A) relative to the coordinate positions around the peaks are approximate to a quadratic curve.

That is, as described above with reference to FIG. 5(A), the position detection signal S6 that is obtained from the position detection signal output unit 14 is calculated from a synthesis prediction value of the detection output signals V3 and V2 and V4 supplied from the three loop coils J3 and J2 and J4 which are changed in such a way as to be approximate to a quadratic function. Based on this fact, as for the specified position detection waveform W0, the following formula is used.

[Formula 2]

y=ax²+bx+c (2)

In this manner, conversion result y can be calculated by the quadratic equation with respect to the change of variable x in the xy coordinate system.

The quadratic equation of the formula (2) is described below with reference to FIG. 7.

[Formula 3]

y=a^{x2} (3)

A basic quadratic curve represented by the above formula is moved in parallel by coordinate p in the x-axis direction, and then is moved in parallel by coordinate q in the y-axis direction. As a result, the quadratic equation is transformed into the following formula.

[Formula 4]

y=a(x−p)²+q (4)

In this manner, the quadratic equation is transformed into the above formula.

The process of transforming the formula (2) to the formula (4) is referred to as “square completion”.

A general quadratic function equation expressed by the formula (2) can be transformed into a square completion equation in the following manner.

$$\begin{matrix}[ Formula 5 ] & \\ \begin{matrix}y = {ax}^{2} + bx + c \\ = a ( {x}^{2} + \frac{b}{a} x ) + c \\ = a \{ {x}^{2} + 2 \times \frac{b}{2 a} + {( \frac{b}{2 a} )}^{2} - {( \frac{b}{2 a} )}^{2} \} + c \\ = a \{ {( x + \frac{b}{2 a} )}^{2} - {( \frac{b}{2 a} )}^{2} \} + c \\ = {a ( x + \frac{b}{2 a} )}^{2} - \frac{{b}^{2}}{4 a} + c \\ = {a ( x + \frac{b}{2 a} )}^{2} - \frac{{b}^{2} - 4 ac}{4 a}\end{matrix} & ( 5 )\end{matrix}$$

In that manner, the equation can be transformed into a square completion equation.

Peak (p, q) of the quadratic curve of the formula (5) is expressed by the following formula.

$$\begin{matrix}[ Formula 6 ] & \\ ( p , q ) = ( - \frac{b}{2 a} , \frac{{b}^{2} - 4 ac}{4 a} ) & ( 6 )\end{matrix}$$

The axis of the curve that has been moved in parallel is expressed by the following formula.

$$\begin{matrix}[ Formula 7 ] & \\ x = - \frac{b}{2 a} & ( 7 )\end{matrix}$$

In that manner, the axis is represented by the above formula.

As for the straight line x represented by the formula (7), the information necessary for identifying an X-axis-direction coordinate position specified by the position specifying tool 5 on the X-axis loop coil plate unit 11 needs to be expressed by the detection outputs V3 and V2 and V4 obtained from the three loop coils J3 and J2 and J4. Accordingly, unknown quantities a and b in the formula (7) may be calculated from conditions of the two loop coils J2 and J4 on both sides.

The following formulae are quadratic equations corresponding to the two loop coils J2 and J4 that hold the centrally positioned loop coil J3 therebetween.

[Formula 8]

y2=ax²+bx+c (8)

[Formula 9]

y4=ax²+bx+c (9)

Unknown quantities a and b of the above formulae are calculated.

Here, with respect to the center loop coil J3, it is possible to assume that the right-side loop coil J4, whose X coordinate value is large on the X-axis loop coil plate unit 11, has been moved in parallel in a positive direction relative to the center loop coil J3. Therefore, the following formula is established.

[Formula 10]

y4=ax²+bx+c (10)

In this manner, the quadratic equation can be established. Meanwhile, it is possible to assume that the left-side loop coil J2, whose X coordinate value is small, has been moved in parallel in a negative direction relative to the center loop coil J3. Therefore, the following formula is established.

[Formula 11]

y2=ax²−bx+c (11)

In this manner, the quadratic equation can be established.

From both sides of the equation (10), both sides of the equation (11) are subtracted. Then, the relationship of the following formula becomes clear.

$$\begin{matrix}[ Formula 12 ] & \\ \begin{matrix}y 4 - y 2 = ( {ax}^{2} - bx + c ) - ( {ax}^{2} + bx + c ) \\ = - 2 bx\end{matrix} & ( 12 )\end{matrix}$$

In this manner, it is clear that there is the above relationship.

From the relationship of the formula (12), unknown quantity b is calculated.

$$\begin{matrix}[ Formula 13 ] & \\ b = \frac{( - 1 ) \times ( y 4 - y 2 )}{2 x} & ( 13 )\end{matrix}$$

In this manner, unknown quantity b can be calculated based on the detection signal values V2 and V4, which are obtained from the both-side loop coils J2 and J4.

At this time, the coordinates x3 and x2 and x4 of the central positions of the coil widths of the three loop coils J3 and J2 and J4 are fixed values, while x is a variable.

[Formula 14]

x2=−1 (14)

[Formula 15]

x3=0 (15)

[Formula 16]

x4=1 (16)

In that manner, even if the coordinates of the center loop coil J3 are expressed as x=0, and if the center coordinates of the left- and right-side loop coils J2 and J4 are expressed as x=−1 and x=1, respectively, each quadratic equation can be established.

The following equation is for the center loop coil J3.

[Formula 17]

y3=ax²+bx+c (17)

If the value, x=0, is substituted into the above equation, then:

[Formula 18]

y3=a×0²+b×0+c (18)

The result of the calculation is:

[Formula 19]

V3=c (19)

Therefore, it is clear that y3 (=V3) is equal to unknown quantity c.

As a result of analysis on the above formulae (2) to (19), it is clear that, by making use of the fact that the position detection signal values V3 and V2 and V4, which are obtained from the three loop coils J3 and J2 and J4, are changed in such a way as to approximate to a quadratic function, unknown quantities b and c of the quadratic function representing the specified position detection waveform W0 can be expressed by the detection signal values V3 and V2 and V4.

In this case, variable x corresponds to coordinate values of the loop coils J3 and J2 and J4. At the same time, this variable represents the distance K01, or the coil pitches K1, K2, and K3 (FIG. 4(A)) between the center loop coil J3 and the both-side loop coils J2 and J4.

In light of the above fact, the above formula (9) is used to calculate unknown quantity a from the coil pitch K01.

That is, unknown quantity b calculated from the formula (13), and unknown quantity c calculated from the formula (19) are substituted into the above formula (9), and the following formula is obtained.

$$\begin{matrix}[ Formula 20 ] & \\ V 2 = {ax}^{2} + \frac{( V 2 - V 4 ) \times x}{2 x} + V 3 & ( 20 )\end{matrix}$$

Based on the formula (20), the following formula is used.

$$\begin{matrix}[ Formula 21 ] & \\ {ax}^{2} = - \frac{2 V 3 - 2 V 2 + ( V 2 - V 4 )}{2} & ( 21 )\end{matrix}$$

With the above formula, a relational expression that includes unknown quantity a is extracted. Then, the formula (21) is used.

$$\begin{matrix}[ Formula 22 ] & \\ a = - \frac{2 V 3 - V 2 - V 4}{2 {x}^{2}} & ( 22 )\end{matrix}$$

In this manner, unknown quantity a is calculated.

In that manner, all of unknown quantities a, b, and c of peak coordinate values (p, q) of the xy coordinate system obtained in the above formula (6) are identified. Therefore, x-coordinate value p is:

$$\begin{matrix}[ Formula 23 ] & \\ p = - \frac{b}{2 a} & ( 23 )\end{matrix}$$

Accordingly, the x-coordinate of the peak in the XY coordinate system that represents the specified position detection waveform W0 can be calculated as described below.

$$\begin{matrix}[ Formula 24 ] & \\ X \text{-coordinate} = - \frac{1}{2} \times \frac{- 1 \times ( V 2 - V 4 )}{2 x} \times \frac{- 2 {x}^{2}}{2 V 3 - V 2 - V 4} & ( 24 )\end{matrix}$$

This formula is organized in the following manner.

$$\begin{matrix}[ Formula 25 ] & \\ X \text{-} coordinate = \frac{( V 4 - V 2 )}{2 V 3 - V 2 - V 4} \times \frac{x}{2} & ( 25 )\end{matrix}$$

As a result, the above formula is obtained.

In the formula (25), as shown in the first term of the above equation (1), an interpolation operation value that represents the coordinate deviation of the center loop coil J3 from the center coordinates of the coil width is expressed by the detection outputs V3 and V2 and V4 of the three loop coils J3 and J2 and J4.

According to the above configuration, by using the detection outputs V3 and V2 and V4 of the three loop coils J3 and J2 and J4, the X-direction peak coordinates of the specified position detection waveform W0 can be calculated as a position specified by the position specifying tool 5. Therefore, on the tablet display plate unit 3 of the position specified detection unit 4, when a loop coil within the inner region is specified by the position specifying tool 5, the loop coil can be reliably detected through interpolation.

### (5-2) Example

In the case of the inner-region interpolation calculation of FIG. 6, the coil numbers of the loop coils J2, J3, and J4 are 3, 4, and 5, respectively. As for the coil pitches, K23=K34 (=K01)=700. The detection outputs V2, V3, and V4 are 150, 200, and 100, respectively. In this case, the coordinate value p of the peak P of the specified position detection waveform W0 is calculated as follows.

$$\begin{matrix}[ Formula 26 ] & \\ \begin{matrix}X \text{-} coordinate value = \frac{( 100 - 150 ) \times ( 700 \div 2 )}{2 \times 200 - 150 - 100} + 4 \times 700 \\ = \frac{- 52500}{150} + 2800 \\ = 2450\end{matrix} & ( 26 )\end{matrix}$$

In this manner, by substituting the detection outputs V3 (=200) and V2 (=150) and V4 (=100) of the both-side loop coils J2 (Coil number=3) and J4 (Coil number=5), which are a distance of coil pitch K01=7.00 [mm] away from the center loop coil J3 (Coil number=4), the coordinate value p of the peak P can be calculated.

In this case, the coordinate value p (=2450) of the peak P is smaller than the value (−2800) of the second term of the formula (26), as the center coordinate value of the center loop coil J3, meaning that the coordinates have deviated from the center coordinates of the center loop coil J3 in the left direction (toward the inner region). The value (=−52500÷150) of the first term of the formula (26) reveals the amount of the deviation.

### (6) Interpolation Operation for Edge Region

### (6-1) Embodiment

In the interpolation operation for the edge region, as described above with reference to FIG. 4(A), the coil pitches K1 and K2, which are equal to each other for the inner region, are disposed in such a way as to be the same coil pitch K01. As shown in FIG. 4(B), the coil pitch K3 between the loop coil J4, which is placed in the edge region surrounding the inner region, and the loop coil J3, which is adjacent to an inner side thereof and is an outermost coil in the inner region, is set to a value that is smaller than the inner-region coil pitch K01, or K3=K02.

As a result, the detection output V4 that is obtained from the inner region's outermost loop coil J3 has a level distribution that is similar in shape to those of the detection output signals V1, V2, and V3 of the inner-region loop coils J1, J2, and J3, as shown in FIG. 5(B). Therefore, with the use of two loop coils, i.e. the edge-region loop coil J4 and the loop coil J3 that is adjacent to the inner side thereof, for the coordinate position specified by the position specifying tool 5, based on the detection outputs V4 and V3 obtained from the two loop coils J4 and J3, an interpolation operation is carried out for the specified position in the edge region.

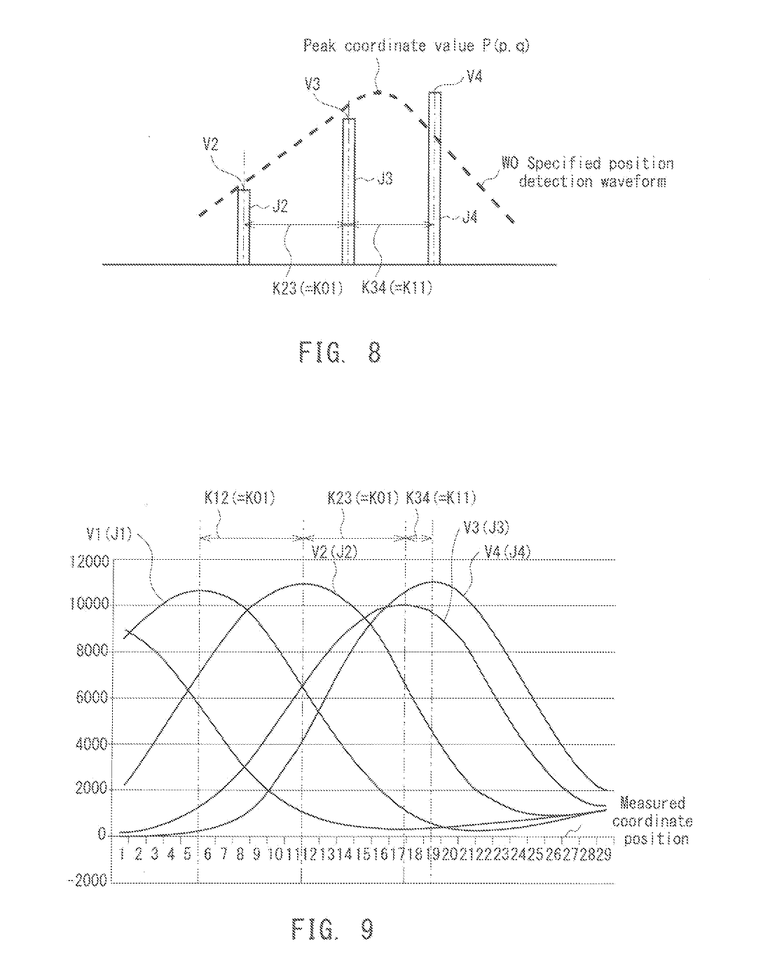

In this case, as shown in FIG. 8, from the edge-region loop coil J4, the detection output signal V4 is obtained. Moreover, the peak coordinate value (p, q) of the specified position detection waveform W0, which is predicted from the detection output signals V3 and V2 obtained from the inner-region loop coils J3 and J2 disposed on the inner side thereof, is calculated by interpolation operation.

In this case, the position specified by the position specifying tool 5 is the position of the edge-region loop coil J4. Accordingly, the signal level of the detection output signal V4 thereof is larger than that of the detection output signal V3 of the inner-region loop coil J3 that is adjacent to the inner side thereof. Therefore, the interpolation operation that uses the larger detection signal V4 of the loop coil J4 results in higher interpolation accuracy.

Therefore, to the peak coordinate value p of the specified detection waveform W0, an interpolation operation is performed by the following formula.

$$\begin{matrix} [ Formula 27 ] & \\ Peak coordinate value p = \frac{( V 4 - V 3 ) \times ( Coil pitch K 11 \div 2 )}{V 4} + ( Coil number of J 4 - 1 ) \times ( Coil pitch K 12 ) + ( Coil pitch K 11 ) & ( 27 )\end{matrix}$$

In this manner, the accuracy of detecting the position specified by the position specifying tool 5 is improved.

In the formula (27), the first term represents the value of coordinate deviation from the edge-region reference loop coil J4, from which a valid detection output can be obtained, to the peak coordinate value p, and also represents the coordinate value of the loop coil J4 of the second term on the X-axis loop coil plate unit 11.

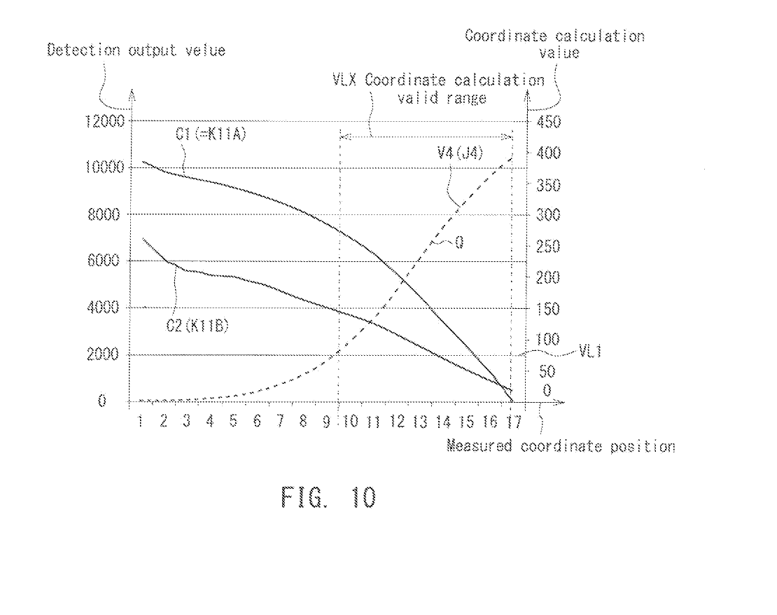

The formula (27) is configured based on measured values of measured signal waveforms V1 to V4 represented by the signal waveforms V1 to V4 of FIG. 9.

The signal waveforms V1 to V4 of FIG. 9 represent, when the position specifying tool 5 is experimentally positioned sequentially at measured coordinate positions 1 to 29 for the inner-region loop coils J1 to J3 adjacent to the edge-region loop coil J4 of the X-loop coil plate unit 11, detection output values of the position detection output signals S6 obtained from the position detection signal output unit 14 (FIG. 2). The coil pitch K12 between the inner-region loop coils J1 and J2, and the coil pitch K23 between the inner-region loop coils J2 and J3 are set to the same value K01. The coil pitch K34 between the inner region's outermost loop coil J3 and the edge-region loop coil J4 is set to a value that is smaller than the inner-region coil pitch K01, or to K11 (which is about one-third of the value, for example).

The measured signal waveform reaches a peak at the central position of the coil width. In a region where the detection outputs of the adjacent loop coils cross each other, mountain-shaped waveforms appear sequentially.

Accordingly, if the peak position of each waveform is detected, it is clear that the coordinates of the central positions of the coil widths of the loop coils J1, J2, J3, and J4 have been specified by the position specifying tool 5. This means that the distance from one peak position to a next peak position is a coil pitch.

Among the measured signal waveforms V1 to V4 of FIG. 9, particularly under the condition that the coil pitch K34 (=K11) between the loop coil J4 placed in the edge region and the loop coil J3 placed on the outermost side of the inner region is set to a value smaller than the coil pitches K3 and K34 (=K01) between the loop coils J3 and J2 and J1 that are placed in the inner region, if the peak coordinate value p is calculated by the above formula (27), the peak coordinate value p enables an interpolation operation for the peak coordinate value (p, q) of the specified position detection waveform W0 of FIG. 8.

As for the peak coordinate value (p, q), the loop coil J4 placed in the edge region has a larger value than the detection output V4 of the loop coil J3 placed in the inner region that is on the inner side thereof. Therefore, the detection output of the loop coil J4 placed in the edge region is in a valid range, and it is possible to interpolate a highly effective peak coordinate value. This means that a specified position detection range of the X-axis loop coil plate unit 11 is expanded from the inner region to the edge region surrounding the inner region.

Here, the configuration of an interpolation operation formula based on measured values of the formula (27) is the same as that of an interpolation interpolation formula by approximate conversion on the three inner-region loop coils as described above with respect to the formula (1). As for the formula (1), the detection outputs of the loop coils including the reference loop coil, and the specified position detection waveform W0 are approximate to a quadratic function. Therefore, the formula (1) is an approximate operation formula that converts an unknown quantity of the quadratic function based on the installation conditions of the loop coils of the X-axis loop coil plate unit 11. Thus, as a result of evaluation, it can be concluded that the accuracy of the results of conversion of the peak coordinates is high.

On the other hand, the conversion formula of the formula (27) is similar to the approximate operation formula of the quadratic function in terms of the configuration of the formulae. However, the formula (27) is defined based on the detection output signals of FIG. 5(B), which are obtained in advance in the X-axis loop coil plate unit 11 as measured values. Therefore, it can be said that the accuracy of the results of conversion thereof, too, is high in such a way as to match the measured values.

### (6-2) Example

In an example of an interpolation operation for the edge region that uses two loop coils of FIG. 8, suppose that the detection output levels of the loop coils J2, J3, and J4 are 50, 150, and 200, respectively; that the coil number of the edge-region loop coil J4 is 9; that the coil pitch K34 (=K11) between the loop coil J4 and the inner-region loop coil J3 that is on the inner side thereof is 5.00 [mm]; and that the coil pitch K23 (=K01) between the inner-side loop coil J3 and the adjacent inner-side loop coil J2 is 7.00 [mm]. At this time, the peak coordinate value p is calculated by the following formula.

$$\begin{matrix}[ Formula 28 ] & \\ \begin{matrix}Peak coordinate value p = \frac{( 200 - 150 ) \times ( 500 \div 2 )}{200} + \\ ( 9 - 1 ) \times 700 + 500 \\ = 616.5\end{matrix} & ( 28 )\end{matrix}$$

In this manner, a coordinate position of 6162.5 can be detected.

Incidentally, when the detection output V4 of the edge-region loop coil J4 is equal to the detection output V3 of the inner-region loop coil J3, the position specified by the position specifying tool 5 is judged to be the center coordinate value of the loop coil J4 as a result of the operation. When the detection output V4 is smaller or larger than V3, the position specified by the position specifying tool 5 is judged to be a coordinate value on an inner or outer side of the loop coil J4 as a result of the operation.

### (7) Correction of Interpolation Operation Formula

As described above, by using the formula (27), it is possible to obtain a detection output signal in the valid range from the loop coil placed in the edge region of the X-axis loop coil plate unit 11 based on the interpolation operation formula that is determined based on the measured values. Therefore, even when the edge region is specified by the position specifying tool 5 with the use of a detection output of a loop coil that is adjacent in the inner region formed on the inner side of the edge region, it is possible to detect the specified position with high accuracy by performing the interpolation operation.

In the case where the interpolation operation for the edge region is carried out as described above, as for the coil pitch K34 (=K11) between the edge-region loop coil J4 used in the formula (27) and the inner-region loop coil J3 placed on the inner side thereof, if the value thereof is changed to a larger or smaller value as indicated by curve C1 or C2 in FIG. 10, a coordinate calculation value obtained by the interpolation operation is linearly changed in a coordinate calculation valid range VLX as a result. Therefore, for the formula (27), the following formula may be used.

$$\begin{matrix} [ Formula 29 ] & \\ Peak coordinate value p = \frac{( V 4 - V 3 ) \times ( Coil pitch K 11 \div 2 )}{y 2 d} \times ( Correction coefficient H 1 ) + ( ( Coil number of V 4 - 1 ) \times Coil pitch K 12 + Coil pitch K 11 ) & ( 29 )\end{matrix}$$

In this manner, if a correction operation coordinate value is corrected by correction coefficient H1, the accuracy of the correction operation value can be further increased.

As for the measured signal waveform V4 (or the detection output V4 obtained from the edge-region loop coil J4), which is described above with reference to FIG. 9, measured coordinate values 1 to 17 have been extracted and indicated by wavy line in FIG. 10. In the waveform of the detection output V4, take a look at a range Q whose valid level VAL1 is greater than or equal to 2000. To a coordinate calculation curve C1 of the case where the coil pitch K11 is a large value that is equal to K11A, a coordinate calculation curve C2 of the case where the coil pitch K11 is a small value K11B is compared. Both curves corresponding to the coordinate calculation valid range Q decrease in an almost linear relationship. Until the two curves reach between the measured coordinate values 16 and 17 (which is a point where the detection outputs V4 and V3 cross each other, or a position corresponding to a lower limit of the coordinate calculation valid range VLX), the curves linearly decrease with different slopes.

Accordingly, if the coordinate calculation values from the two curves are corrected based on, for example, the ratio of the linear slopes with the use of the coil pitches K11A and K11B that are actually selected, the effects on the results of the two-curve coordinate calculation values can be corrected.

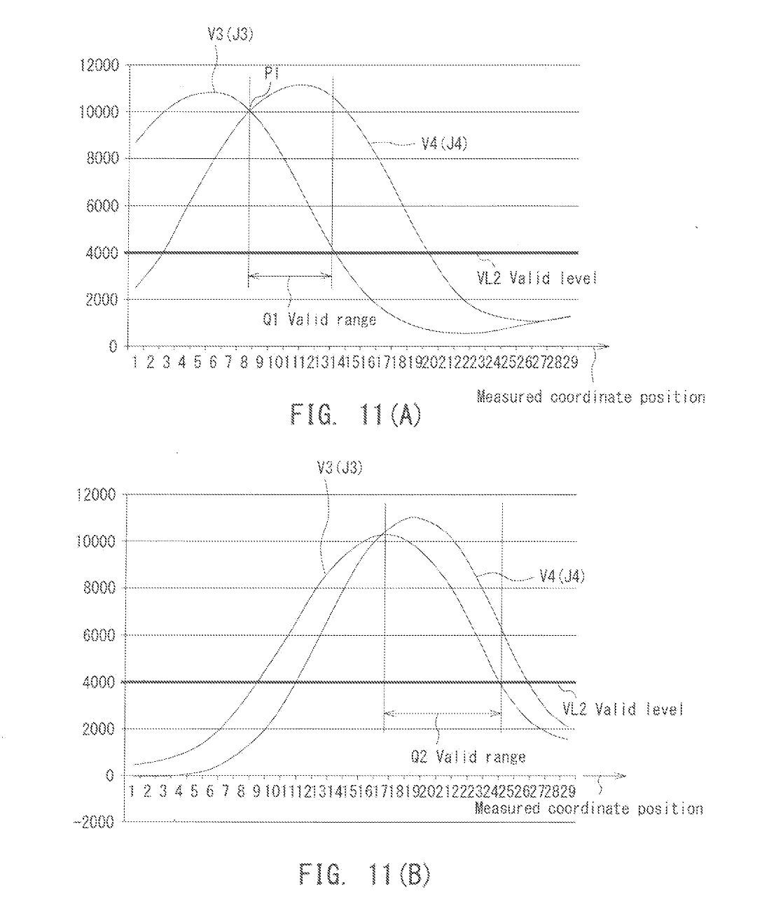

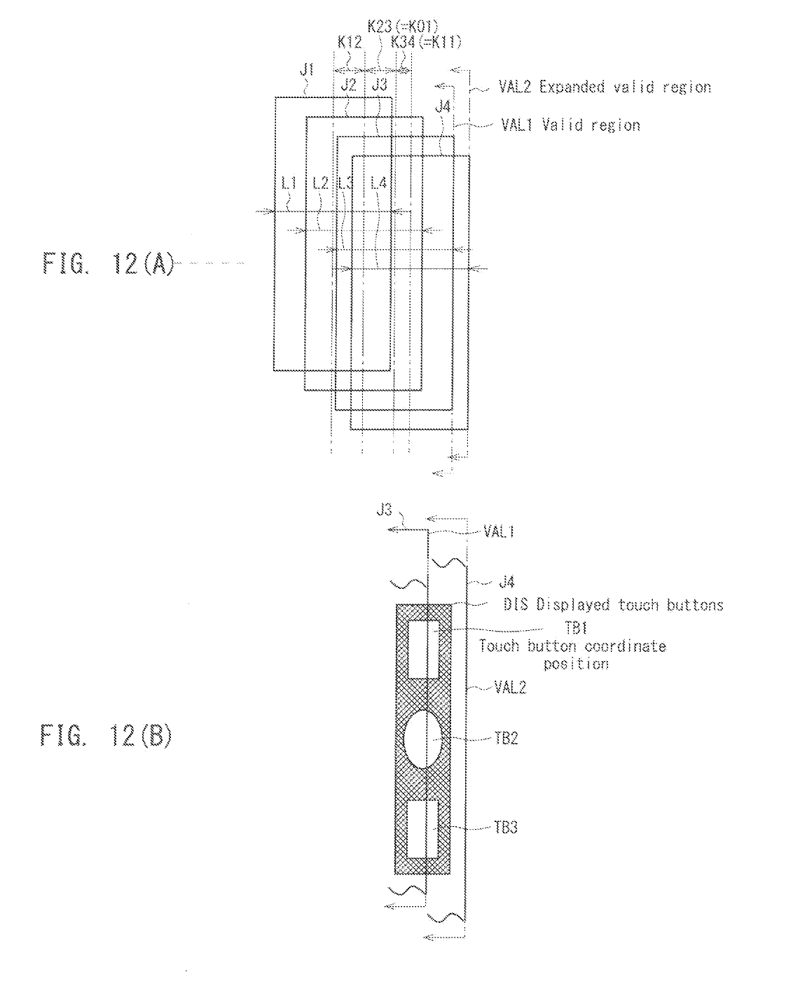

As for the effects of the correction with the coil pitches K11A and K11B, as shown in FIGS. 11(A) and 11(B), in the case where the coil pitch K34 (K=11) between the loop coil J4 placed in the edge region and the loop coil J3 placed on the inner side thereof is large (FIG. 11(A)), when a calculation valid range Q1 extending from a measured coordinate position P1 where the detection outputs V4 and V3 of both cross each other to a point where the detection output V4 of the inner-side loop coil J3 drops below a valid level V2 is compared to a valid range Q2 of the case where the value of the coil pitch K34 (K=11) is small, as shown in FIG. 11(B), the range Q2 of the case where the coil pitch K34 (K=11) is small is wider.

As a result, when the coil pitch K34 (K=11) is small, the valid range Q2 is wider. In this case, the measured coordinate positions extend further to the position of an end of the X-axis loop coil plate unit 11, and the valid coordinate range is expanded.

If correction coefficient H1 of the formula (29) is corrected depending on the magnitude of the coil pitch K34 (=K11), the correction operation range expands in such a way as to cover the position of the outermost-side end of the edge region. Therefore, it is clear that effectiveness of the interpolation operation is large.

Incidentally, as the coil pitch K34 (=K11) becomes smaller, the valid coordinate range is expanded in such a way as to cover the position of the end. However, a too small coil pitch reduces the effects of the interpolation calculation. Accordingly, a limit value of the coil pitch is determined by simulation or actual measurement.

If the valid coordinate range is expanded by reducing the coil pitch, the advantage is that an outer peripheral edge portion of the tablet display plate unit 3, or the display region of the tablet, is widened, and that an invalid region between an outer edge of a loop coil and the display region becomes narrower. Therefore, the loop coil is expected to be contained in the display region of the tablet. According to conventional techniques, in order to keep coordinate accuracy, the loop coil needs to protrude from the display region of the tablet, and the outer peripheral edge portion of the tablet display plate unit 3 requires a frame. According to this technique, a tablet with a narrow frame or no frame can be made.

With the use of FIG. 14, the following shows evidence that a tablet with a narrow frame or no frame can be made. FIG. 14(A) shows the case of a conventional technique. FIG. 14(B) shows the case of an embodiment of the present invention. The diagrams show one outer edge portion of an X-axis loop coil. The same is true for other outer edge portions and those of a Y-axis loop coil.

In the coil arrangement diagram of FIG. 14(A), central portions of loop coils where detection signals of X-axis loop coils J11 to J13 reach peaks are represented by P11 to P13, respectively. The detection signals of the loop coils are represented by V11 to V13, as shown in the detection output signal diagram in the middle portion of FIG. 14.

In order to calculate a coordinate value, the detection output signals from at least two loop coils need to be obtained as signals whose detection values are greater than or equal to valid level VL2. Accordingly, a valid region VAL1 in which the second detection output V12 from the end is greater than or equal to the valid level VL2 is the limit of being able to perform coordinate calculation.

Outside of the valid region VAL1, and between the valid region VAL1 and an outer side G1 of the coil, an invalid region UN1 exists. The invalid region UN1 cannot be used as a display region 15 of the tablet display plate unit 3. The invalid region UN1 is turned into a frame 16 because the loop coils need to be housed in the device.

In the coil arrangement diagram of FIG. 14(B), central portions of loop coils where detection signals of X-axis loop coils J21 to J24 reach peaks are represented by P21 to P24, respectively. The detection signals of the loop coils are represented by V21 to V24, as shown in the detection output signal diagram in the middle portion of FIG. 14.

In order to calculate a coordinate value, the detection output signals from at least two loop coils need to be obtained as signals whose detection values are greater than or equal to valid level VL2. Accordingly, a valid region VAL2 in which the second detection output V23 from the end is greater than or equal to the valid level VL2 is the limit of being able to perform coordinate calculation.

Outside of the valid region VAL2, and between the valid region VAL2 and an outer side G2 of the coil, an invalid region UN2 exists. The invalid region UN2 cannot be used as a display region 15 of the tablet display plate unit 3. The invalid region UN2 is turned into a frame 16 because the loop coils need to be housed in the device.

Here, the width of the invalid region UN1 of the example of the conventional technique of FIG. 14(A) is compared with the width of the invalid region UN2 of the embodiment of the present invention of FIG. 14(B). It is clear that the width of the invalid region UN2 of FIG. 14(B) is narrower. If the coil pitches and the valid level VL2 are set lower, it is possible to eliminate the frame 16 and to put the loop coils inside the display region. Therefore, it is obvious that a tablet with a narrow frame or no frame can be made.

### (8) Operation and Effects

The facts described above for the configuration of the above X-axis loop coil plate unit 11 are similarly applied to the Y-axis loop coil plate unit 12. In the inner region thereof, with the use of the three loop coils, as for the position specified by the position specifying tool 5, an interpolation operation for the peak coordinate value (p, q) is performed. Moreover, the coil pitch K34 (=K11) between the loop coil J4, which is placed in the edge region surrounding the outer side of the inner region, and the loop coil J3, which is placed in the inner region, is set to a value that is smaller than the coil pitches K32 and K21 (=K01) between the inner-region loop coils J3 and J2 and between the inner-region loop coils J2 and J1. Therefore, it is possible to detect, with high accuracy, the positions specified by the position specifying tool 5 not only in the inner region but also in the edge region.

### (9) Other Embodiments

### (9-1) Operation of Operation Changeover Switch Provided in Edge Region

As for the edge region that surrounds the loop coils placed in the inner region of the X-axis loop coil plate unit 11, in the above-described embodiment, even when the edge region is specified by the position specifying tool 5, the specified position is detected with high accuracy with the use of a coordinate position interpolation function of the inner-region loop coils. In addition, if an operation changeover switch that is used to switch a processing operation of the information processing device 1 is provided in the edge region with the use of the tablet display plate unit 3, the device is so designed as to detect the operation changeover switch.

(9-1-1) Use of Expanded Coordinate Valid Area

FIG. 12 shows a modified example in which, in a valid region that has been expanded in the edge region by the above two loop coils, the edge region that surrounds the inner region of the tablet display plate unit 3 is configured in such a way as to be available for a touch button specifying operation through which an operation input disposed in the information processing device 1 can be input.

In this case, as shown in FIG. 12(A), outside of a valid region VAL1 in which coordinates can be specified with the help of three loop coils, there is an expanded valid region VAL2 in which coordinate positions can be specified with the help of two loop coils. In the case where this configuration is used, in the expanded valid region VAL2, when three touch button coordinate positions TB1, TB2, and TB3 of displayed touch buttons DIS are specified by the position specifying tool 5 as shown in FIG. 12(B), the central processing unit 2 assumes, based on the coordinate detection position information, that a touch button operation input has been input into the information processing device 1, and therefore detects the coordinate positions.

In the case of this embodiment, the detection output signals that are obtained from the loop coils of the Y-axis loop coil plate unit 12 formed in such a way as to overlap with the X-axis loop coil plate unit 11 are used to detect which one out of the three touch buttons DB1, DB2, and DB3 making up the displayed touch buttons DIS has been specified by the position specifying tool 5. Suppose that a touch button is touched when a tap operation or a switch operation is performed by the position specifying tool.

In that manner, in a display region that was considered to be a decorative portion in which an outer peripheral edge portion of a conventional tablet display plate unit 3 could not be used, the interpolation operation by the two loop coils makes it possible to detect a position specified by the position specifying tool 5. Using this configuration, it is possible to realize an information processing device 1 that can detect a touch button operation input to the information processing device 1.

(9-1-2) Loop Coil for Detecting Touch Buttons

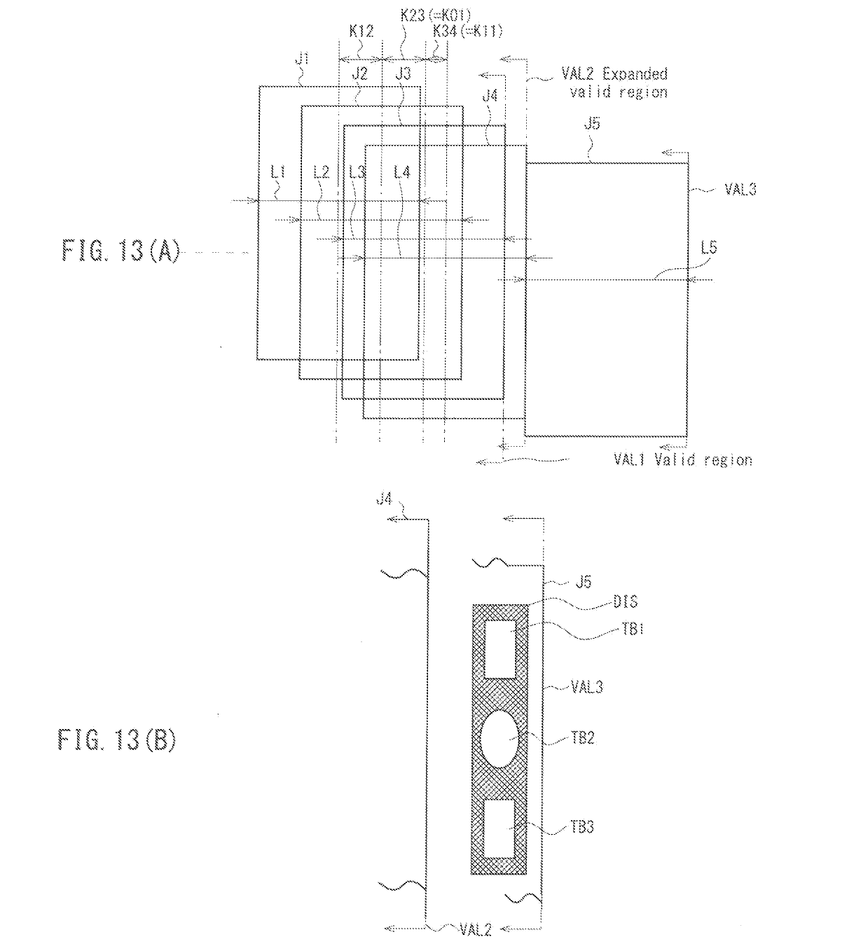

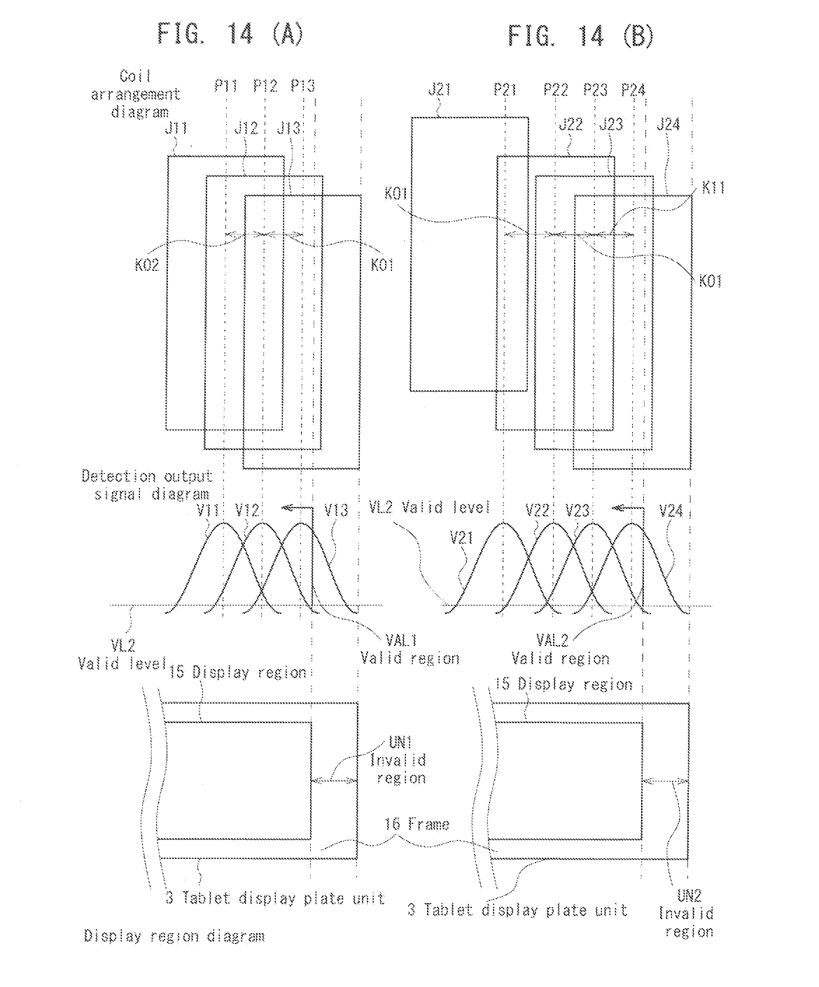

FIG. 13 shows an embodiment of the case where a loop coil J5 for detecting touch buttons is provided outside the edge region, showing an example of the case where touch buttons are placed away from the outer peripheral edge portion of the tablet display plate unit 3. In the case of FIG. 12(A), in the edge region, by the outermost loop coil J4 which is one of the two loop coils, specified coordinates on the displayed touch buttons DIS are detected through an interpolation operation. In the case of FIG. 13(A), outside of the outermost loop coil J4, a loop coil J5 that is dedicated to detecting touch buttons is provided. Therefore, outside of the valid region VAL2 expanded by the two loop coils J3 and J4, a valid region VAL3 that is dedicated to the touch buttons is formed.

The loop coil J5 that is dedicated to the touch buttons transmits a detection output to the central processing unit 2 when the displayed touch buttons DIS, which are displayed in the edge region corresponding to an outer frame section of the tablet display plate unit 3, are specified by the position specifying tool 5, thereby notifying the central processing unit 2 of the fact that the displayed touch buttons DIS have been specified by the position specifying tool 5.

In the case of this embodiment, when a signal level of the loop coil J5 dedicated to detecting the touch buttons is greater than a certain level, the detection output signals that are obtained from the loop coils of the Y-axis loop coil plate unit 12 formed in such a way as to overlap with the X-axis loop coil plate unit 11 are used to detect which one out of the three touch buttons DB1, DB2, and DB3 making up the displayed touch buttons DIS has been specified by the position specifying tool 5. Suppose that a touch button is touched when a tap operation or a switch operation is performed by the position specifying tool.

According to the configuration of FIG. 13, outside of the valid region VAL1 formed by the three loop coils in the central region, the valid region VAL2 expanded by the two loop coils is formed. Outside of the valid region VAL2, the valid region VAL3 is formed by the loop coil dedicated to the touch buttons. Thus, it is possible to realize an information processing device in which the position specifying tool 5 can specify a position on an outer frame of the tablet display plate unit 3.

(9-2) According to the above embodiment, the connection relationship between the loop coils of the X-axis loop coil plate unit 11 and Y-axis loop coil plate unit 12 is fixed, and the coil widths and coil pitches of the loop coils are therefore determined in a fixed manner. Instead, an X-axis loop coil plate unit and a Y-axis loop coil plate unit may be adopted in such a way as to be able to change the connection relationship of the loop coils. In this case, it is possible to further increase the coordinate interpolation accuracy.

Incidentally, as for the changing of the connection between the loop coils of the X-axis loop coil plate unit and Y-axis loop coil plate unit, what is disclosed in FIG. 3 of PCT/JP2013/007081, as prior art, is the configuration for changing the connection relationship between the X-axis lines and Y-axis lines of the X-axis line plate unit and Y-axis line plate unit. This configuration may be used to change the coil pitch of the two loop coils as the matters described above with reference to FIG. 10 are applied. In this case, it is possible to further increase the accuracy of the coordinates specified, which are obtained after the interpolation operation.

(9-3) In the above embodiment, the number of turns in the loop coils is one. However, the present invention is not limited to this. The same advantageous effects as those described above can be achieved even when the number of turns is increased.

(9-4) In the above embodiment, the coil widths of the loop coils are equal. However, the present invention is not limited to this. The same advantageous effects as those described above can be achieved even when the widths of the loop coils are varied.

### INDUSTRIAL APPLICABILITY

The present invention can be used to obtain position information of a position specified through an operation panel display surface.

### EXPLANATION OF REFERENCE SYMBOLS

1: Information processing device
2: Central processing unit
3: Tablet display plate unit
4: Specified position detection unit
5: Position specifying tool
6: Specified position detection control unit
11: X-axis loop coil plate unit
12: Y-axis loop coil plate unit
13: Drive signal input unit
14: Position detection signal output unit
21Y1 to 21YM: Drive input switch
22: Pulse drive switch
25: Input-side resonance capacitor
31: Output-side resonance capacitor
32: Output differential amplifier circuit
33X1 to 33XN: Position detection output switch
37: Synchronous detection circuit
41: Tuning coil
42: Tuning capacitor
X1 to XN: X-axis loop coil
Y1 to YM: Y-axis loop coil

1. A specified position detection device that obtains, when a position is specified by an electromagnetic coupling-type position specifying tool on a coordinate position specifying surface on which a plurality of loop coils making up an XY coordinate system are disposed, a specified coordinate detection output from a loop coil electromagnetically coupled with the position specifying tool among the loop coils located at the specified position, characterized in that:
based on a first position detection output value, which is obtained from a first loop coil located in an edge region surrounding an inner region among the plurality of loop coils, a second position detection output value, which is obtained from second loop coils located in the inner region that are adjacent to an inner side of the first loop coil, and a first coil pitch between the first and second loop coils, an interpolation operation is performed of a coordinate deviation value from the first loop coil to a peak coordinate value of the specified coordinate detection output in order to detect coordinates of the position specified by the position specifying tool; and the first coil pitch is a different value from a value of the second coil pitch between the second loop coils located in the inner region.

2. The specified position detection device according to claim 1, characterized in that
the first and second position detection output values and the first coil pitch are set in a range where a high level of coordinate accuracy is obtained due to measured values obtained from the first and second loop coils or simulation, depending on a required valid coordinate detection range.

3. The specified position detection device according to claim 2, characterized in that
an interpolation operation value of the coordinate deviation value is corrected based on magnitude of the coil pitch between the first and second loop coils.

4. The specified position detection device according to claim 1, characterized in that
based on an inner-region position detection output value obtained from three loop coils that are adjacent to each other in the inner region, an interpolation operation is performed of a coordinate deviation value up to a peak coordinate value of the specified coordinate detection output of the inner region.

5. The specified position detection device according to claim 4, characterized in that
an interpolation operation of coordinate deviation value up to a peak coordinate value of the specified coordinate detection output of the inner region is an approximate operation that uses a quadratic function formula.

6. The specified position detection device according to claim 1, characterized in that:
a displayed touch button is formed in the edge region of the coordinate position specifying surface; and, when a position is specified by the position specifying tool on the displayed touch button, the first position detection output value obtained from the first loop coil is used to determine a position specified output for the displayed touch button.

7. The specified position detection device according to claim 1, characterized in that:
in an outer peripheral edge portion of the edge region of the coordinate position specifying surface, a displayed touch button is formed away from an outer peripheral edge portion of a tablet display plate unit; and, when a position is specified by the position specifying tool on the displayed touch button, a third position detection output value obtained from a third loop coil disposed at a display position of the displayed touch button is used to determine a position specified output for the displayed touch button.

8. The specified position detection device according to claims 1 to 7, characterized in that:
a loop coil is placed inside a tablet display region; and a tablet is configured in such a way as to have a narrow frame outside of the tablet display region or no frame.
